(19) United States
(12) Patent Application Publication
(10) Pub. No.: US 2024/0251266 A1
(43) Pub. Date: Jul. 25, 2024

(54) COMMUNICATION MONITORING SYSTEM IN CONTROL NETWORK

(71) Applicant: NAGOYA INSTITUTE OF TECHNOLOGY, Nagoya-shi, Aichi (JP)

(72) Inventors: Yoshihiro HASHIMOTO, Nagoya-shi (JP); Toshiaki HONDA, Machida-shi (JP)

(73) Assignee: NAGOYA INSTITUTE OF TECHNOLOGY, Nagoya-shi, Aichi (JP)

(21) Appl. No.: 18/577,415

(22) PCT Filed: Jul. 5, 2022
(86) PCT No.: PCT/JP2022/026731

§ 371 Date: Mar. 20, 2024

(30) Foreign Application Priority Data
Jul. 8, 2021 (JP) 2021-113226

(51) Int. Cl. H04W 24/08; H04W 12/03; H04W 12/04

(52) U.S. Cl. CPC H04W 24/08; H04W 12/03; H04W 12/04

(57) ABSTRACT

A monitoring system comprises a router unit and a monitoring unit. The router unit includes an acquisition unit obtaining a packet encrypted with a first encryption key by a first communication device and sent from the first communication device, the monitoring unit includes a decryption unit decrypting the packet obtained by the acquisition unit with a first decryption key corresponding to the first encryption key and a recording unit recording information based on the decrypted packet, the router unit includes a transfer unit transmitting the encrypted packet to a second communication device, the router unit and the monitoring unit function as OPC UA application integrated within encrypted communications, are equipped with OPC UA server/client functionalities, capable of OPC UA encryption/decryption, and make an inquiry to an OPC UA server as a proxy for an OPC UA client.

### TECHNICAL FIELD

The present invention relates to a communication monitoring system in a control network.

### BACKGROUND ART

In recent years, cyber attacks on critical infrastructures have been on the rise. Consequently, networks establishing Industrial Control Systems (ICS) also need to address security incidents. ICSs are utilized in gas pipelines, power plants, chemical and petrochemical plants, among others. Cyber incidents targeting ICSs pose not only security concerns but also safety and business issues. The repercussions, whether accidents in manufacturing facilities, customers' damages due to improper product shipments, or even temporary service halts in production, are highly impactful.

As a solution in such cases, attention has been drawn to OPC UA (Open Platform Communications Unified Architecture), a platform-independent communication protocol enabling secure communication within ICS. In 2018, OPC UA added the specification for Pub/Sub (Publish/Subscriber) communication, allowing not only one-to-one client/server communication but also multicast communication based on publish/subscribe. This expansion accommodates industrial use cases requiring real-time responsiveness and simultaneous instructions to the field. Consequently, OPC UA is becoming a standard in the industrial sector. Among the highly anticipated features of OPC UA within ICS is data confidentiality, driving the promotion of network encryption (e.g., see non-patent literature 1)

### PRIOR ART LITERATURE

### Patent Literature

### Non-Patent Literature 1

Japan OPC Consortium Technical Committee, “Inquiry on OPC UA Security Functions and Evaluation Results by the German Federal Ministry of Technology Security Department,” [online], [searched on Jul. 22, 2019], Internet <URL: https://jp.opcfoundation.org/wp-content/uploads/sites/2/2017/12/OPCDay2017_04_OPC_UAsec.pdf >

In OPC UA, actual data exchange is encrypted using a symmetric key encryption method, but it is necessary to exchange this encryption key beforehand using asymmetric key encryption. Therefore, the encryption key is strictly managed within the OPC UA application. In other words, it is extremely difficult for a third person to intercept the encrypted network without stealing the encryption key

### SUMMARY OF THE INVENTION

### Technical Problem

OPC UA incorporates internet technologies that have been cultivated over the years in an internet environment rampant with cyber attacks. Payload portions of packets transmitted and received within the network is encrypted. In the case of OPC UA, public key encryption is used for connection sequences at the start of communications, while symmetric key encryption is used for actual data exchange. In public key encryption, exchange of a common key occurs, and since the common key is updated each time at the initiation of OPC UA communications, it is not reused. Therefore, it is extremely challenging for a third party to decrypt the OPC UA network by guessing the common key.

However, when networks are encrypted and the encryption keys used for encryption become more complex, it implies that the contents of communications become undetectable. In the case of ICS, there exist many machines that send commands to controllers. If an ICS employing OPC UA for encrypted communication is compromised by cyber attackers, there is a possibility that normal data exchanges might be transmitted to the controllers as malicious data exchanges. Monitoring an encrypted OPC UA network is challenging using conventional port mirroring. Acquiring packets via port mirroring and using packet analysis tools like Wireshark allows for the analysis of plaintext (unencrypted) packets, but Wireshark currently lacks decryption capability of encrypted transfer data.

If Wireshark were to implement decryption capabilities, it would be necessary to decrypt data encrypted by the public key encryption used in the earlier mentioned common key exchange. In this case, a private key corresponding to a public key used by both the OPC UA server and client would be necessary. Given a feature of ICS dealing with critical infrastructure control systems, exposing the private key from devices externally poses a very high risk of security incidents. Therefore, a method of acquiring the private key externally and decrypting is difficult.

In consideration of the above, it is a goal to enable a device different from communication devices to monitor data encrypted by one of the communication devices and sent to another one of the communication devices within a control network.

### Solution to Problem

An invention solving the above problem is as follows:

[1]A monitoring system for monitoring communication between a first communication device (1) and a second communication device (2) in a control network, comprising: a router unit (4) capable of communication with the first communication device and the second communication device, and a monitoring unit (3) recording information regarding content of communication between the first communication device and the second communication device, wherein: the router unit includes an acquisition unit (450, 470) obtaining a packet encrypted with a first encryption key (CK1) by the first communication device and sent from the first communication device, the monitoring unit includes a decryption unit (340) decrypting the packet obtained by the acquisition unit with a first decryption key (CK1) corresponding to the first encryption key and a recording unit (345) recording information based on the decrypted packet, the router unit includes a transfer unit (460) transmitting the encrypted packet to the second communication device, the router unit and the monitoring unit function as OPC UA application (hereinafter may be also referred to as an OPC UA proxy) integrated within encrypted communications, are equipped with OPC UA server/client functionalities, operate as an OPC UA application, capable of OPC UA encryption/decryption that is the first communication device, and make an inquiry to an OPC UA server that is the second communication device as a proxy for an OPC UA client that is the first communication device. It is noted that “OPC UA encryption/decryption” refers to “encryption and decryption of OPC UA.”
[2] The monitoring system according to [1], wherein the first communication device, the second communication device, and the monitoring unit are all capable of communication through the router unit, wherein the acquisition unit within the router unit alters a destination address of the packet and sends them from the transfer unit, the packet originating from the first communication device has a source address being an address of the first communication device (1) and the destination address being an address (P31) of the router unit and reaches the router unit, at the initiation of communication, the acquisition unit possesses a common key shared between the OPC UA client and the OPC UA server.
[3] The monitoring system according to [2], wherein the router unit and the monitoring unit are capable of communication with each other, the router unit includes a request packet transfer unit (405, 410) rewriting, at the initiation of communication, a destination address of a specific request packet sent from the first communication device from an address (P31) of the router unit to an address (P2) of the second communication device and sending the rewritten packet to the second communication device, the second communication device includes a response unit (310) sending to the router unit a response packet in response to the request packet sent by the request packet transfer unit, by setting a destination address to an address (P32) of the router unit and by setting a source address to the address (P2) of the second communication device, and the router unit changes the source address of the response packet sent by the response unit from the address (P2) of the second communication device to an address (P31) of the router unit and sends the response packet to the first communication device.
[4] The monitoring system according to [3], wherein the request packet from the first communication device includes an electronic certificate of the first communication device, and the corresponding response packet contains an electronic certificate of the monitoring unit.
[5] The monitoring system according to [4], wherein the request packet from the first communication device includes a public key (PK1) corresponding to a private key (SK1) owned by the first communication device, and the response packet includes a public key (PK3) corresponding to a private key (SK3) owned by the monitoring unit.
[6] The monitoring system according to [5], wherein a request packet from the second communication device includes a public key (PK2) corresponding to a private key (SK2) owned by the second communication device, and a corresponding response packet includes a public key (PK3) corresponding to a private key (SK3) owned by the monitoring unit.
[7] The monitoring system according to [6], wherein the first communication device and the monitoring unit share a common key, and the second communication device and the monitoring unit also share a common key.
[8] The monitoring system according to any one [1] to [7], wherein packet routing information between the first communication device, the second communication device, and the router unit is specified using a URL.
[9] The monitoring system according to any one of [1] to [8], wherein the first encryption key and the first decryption key are obtained by the first communication device, the second communication device, and the monitoring unit based on information (NONCE1) shared among the first communication device, the second communication device, and the monitoring unit through communication using asymmetric key encryption.

The monitoring system according to any one of [1] to [9], wherein the router unit obtains a packet encrypted with a second encryption key (CK2) at the second communication device and sent from the second communication device, the monitoring unit decrypts, using a second decryption key (CK2) corresponding to the second encryption key, the packet obtained from the second communication device and encrypted with the second encryption key at the second communication device and records information based on the decrypted packet, and the router unit sends the packet encrypted with the second encryption key by the second communication unit to the first communication device.

Parenthesized reference symbols attached to each constituent element indicate one example of correspondence relationship between the constituent element and specific constituent elements described in the embodiments described later.

### BRIEF DESCRIPTION OF DRAWINGS

FIG. 1A Basic configuration of a communication monitoring system.

FIG. 1B Diagram illustrating a general connection configuration of an OPC UA system.

FIG. 2A Block diagram illustrating a configuration of the communication monitoring system.

FIG. 2B Diagram depicting a communication sequence of OPC UA server/client and monitoring OPC UA application.

FIG. 3A Diagram illustrating the communication procedure between the first communication device and the monitoring unit acting as an agent for the second communication device.

FIG. 3B Diagram illustrating the communication procedure between the second communication device and the monitoring unit acting as an agent for the first communication device.

FIG. 4A Diagram illustrating the procedure for generating common keys CK1 and CK2.

FIG. 4B Diagram illustrating the procedure for generating common keys CK1 and CK2.

FIG. 5 Diagram illustrating the procedure where the monitoring unit and the router unit relay and record data transmitted from the first communication device to the second communication device.

FIG. 6 Diagram illustrating the procedure where the monitoring unit and the router unit relay and record data transmitted from the second communication device to the first communication device.

FIG. 7 Diagram depicting establishment of seamless OPC UA communication.

### DESCRIPTION OF EMBODIMENTS

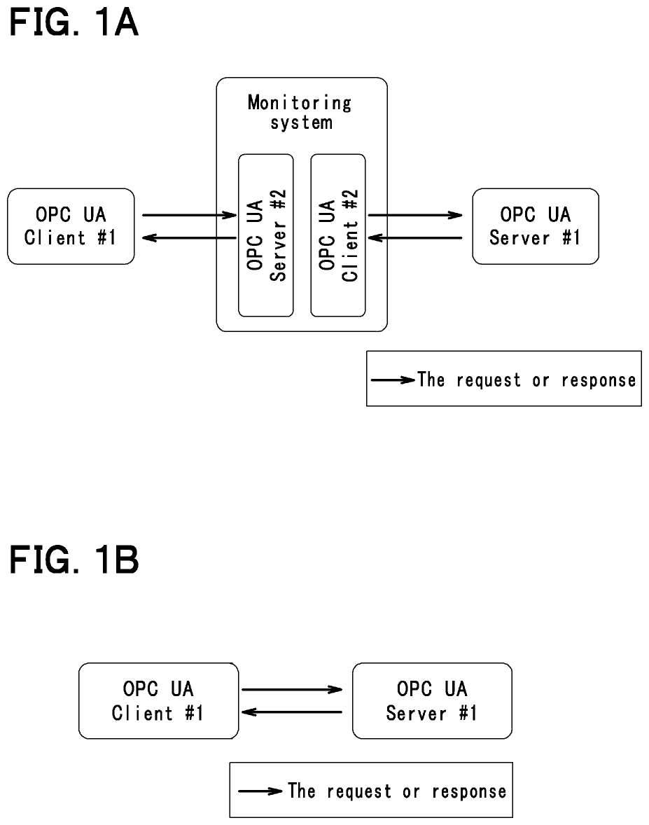

By referring FIG. 1A, a basic configuration of a communication monitoring system in one embodiment of the present invention is explained. In the case of communication between a Client #1 and a Server #1, the Client #1 sends a request to the Server #2, and the Server #2 receives the request. A Client #2 is created as a proxy (i.e., an OPC UA application), forwarding the request to the Server #1. The response follows the same flow in reverse.

During this time, the system retains information necessary for generating a common key used in data exchange. The system holds, as targets of monitoring, the requests/responses transferred through the OPC UA proxy without delaying the transfer, and decrypts them later for monitoring. On the other hand, a general communication monitoring system has a connection configuration as shown in FIG. 1B, in which a connection between a Client #1 and a Server #1 are made without creating a Client #2 as a proxy.

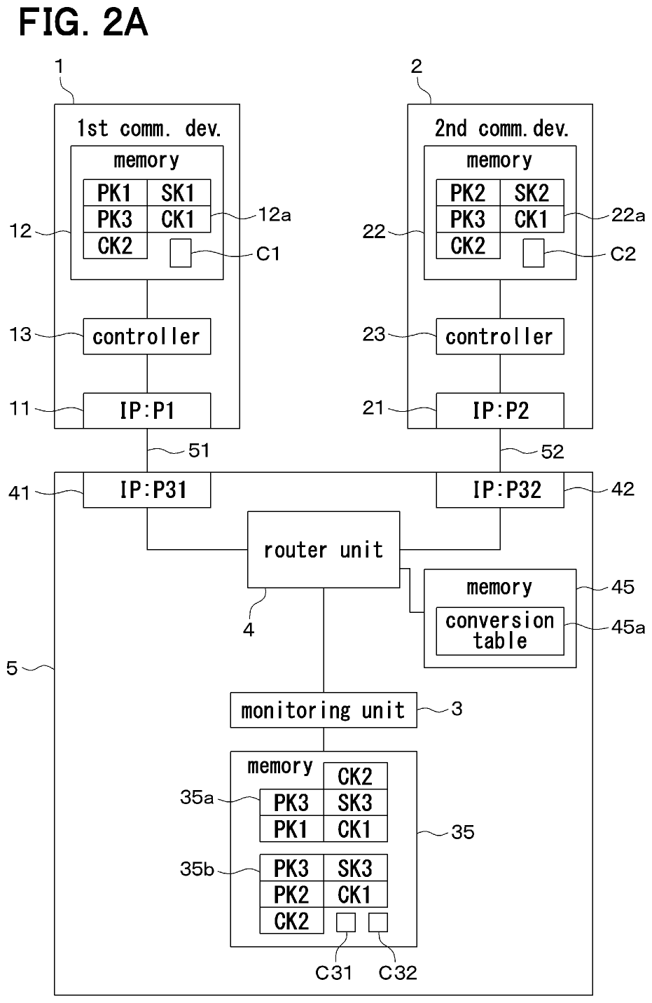

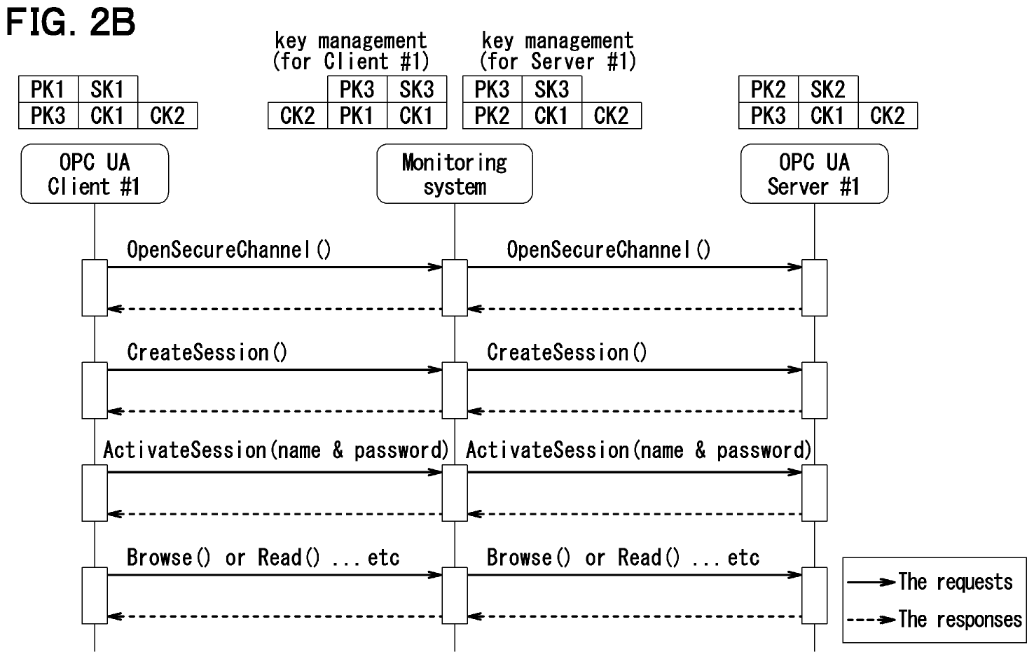

The embodiment of the basic configuration of the communication monitoring system in FIG. 1A is illustrated in FIG. 2A. This monitoring system includes a monitoring system body 5 equipped with a monitoring unit 3 and a router unit 4 to monitor the communication between a first communication device 1 and a second communication device 2.

The monitoring unit 3, the router unit 4, and network connecting them can be made as virtual realization in a single computer. Software like Kernel-based Virtual Machine (KVM) can be used to realize these virtually.

Alternatively, the monitoring unit 3 and the router unit 4 may be realized on separate computers. In this case, the monitoring unit 3 acts as a monitoring device, and the router unit 4 acts as a router. The network between the monitoring unit 3 and the router unit 4 becomes a tangible entity. In the example shown in FIG. 2A, communication between the first communication device 1, the second communication device 2, and the monitoring unit 3 is possible only through the router unit 4, but in other scenarios, direct communication without the router unit 4 might also be possible.

The first communication device 1 and the second communication device 2 are devices connected to industrial control network. For instance, the first communication device 1 could be an aforementioned OPC server (i.e., the Server #1), and the second communication device 2 could be an OPC client like SCADA (i.e., the Client #1). Conversely, the first communication device 1 could be an OPC client like SCADA (i.e., the Client #1), and the second communication device 2 could be an OPC server (i.e., the Server #1). Additionally, for instance, the second communication device 2 could be a controller (e.g., PLC) managing actuators.

As shown in FIG. 2A, the first communication device 1 comprises a network interface 11, memory 12, and a control unit 13. The network interface 11 is an interface circuit used to communicate with the router unit 4 via LAN 51. An IP address P1 is assigned to the network interface 11.

The memory 12 is non-transitory tangible storage medium and includes a RAM, a ROM and a flash memory and the like. The RAM is rewritable non-volatile memory. The ROM is un-rewritable volatile memory. The flash memory is rewritable volatile memory. The ROM or the flash memory holds programs executed by the control unit 13. The flash memory stores key information 12a for the first communication device 1. The key information 12a includes a private key SK1, public keys PK1, PK3, and common keys CK1, CK2. The private key SK1 may be stored in a TPM (Trusted Platform Module) to prevent reading from outside of the TPM. SK1 is a private key for the first communication device 1, while PK1 is the public key corresponding to SK1. The public key PK3 corresponds to the private key SK3 of the monitoring unit 3. The public key PK1 corresponding to the private key SK1 is stored in the monitoring unit 3.

Moreover, the memory 12 stores a certificate C1. The certificate C1 is an electronic certificate that authenticates the legitimacy of the first communication device 1. For instance, the certificate C1 may contain the IP address of the first communication device 1, public key PK1 or other data identifying the first communication device 1

The control unit 13 is a calculation circuit that performs processing described below by reading programs from the ROM or the flash memory. It uses the RAM as a workspace and utilizes data from the ROM and the flash memory during the processing described below. In the processing, the control unit 13 may receive signals from unillustrated input devices and sensors and control unillustrated display devices and industrial actuators (e.g., robots). Hereinafter, processes conducted by the control unit 13 will be explained as performed by the first communication device 1 for simplicity:

The second communication device 2 consists of a network interface 21, memory 22, and a control unit 23. The network interface 21 is an interface circuit communicating with the router unit 4 via LAN 52. An IP address P2 is assigned to the network interface 21.

The memory 22 is non-transitory tangible storage medium and has a RAM, a ROM and a flash memory and the like. The ROM or the flash memory stores programs executed by the control unit 23. The flash memory stores key information 22a of the second communication device 2. The key information 22a includes a private key SK2, public keys PK2, PK3, and common keys CK1, CK2. SK2 is a private key for the second communication device 2, and PK2 is the public key corresponding to SK2. The private key SK2 may be stored in a TPM (Trusted Platform Module) to prevent reading from outside of the TPM. The public key PK3 is a public key of the monitoring unit 3. The public key PK3 corresponding to the private key SK3 is stored in the monitoring unit 3. The public key PK2 corresponding to the private key SK2 is stored in the monitoring unit 3. The memory 22 includes a certificate C2. The certificate C2 is an electronic certificate authenticating the legitimacy of the second communication device 2. The certificate C2 may contain the IP address of the second communication device 2 and the public key PK2. The certificate C2 may contain other data identifying the second communication device 2.

The control unit 23 is a calculation circuit reading programs from the ROM or the flash memory to execute processing described below. The control unit 23 uses the RAM as a workspace and uses data in the ROM and the flash memory during the processing described below. The control unit 23 may receive signals from unillustrated input devices and sensors and control unillustrated display devices and industrial actuators (e.g., robots). Hereinafter, processes conducted by the control unit 23 will be explained as performed by the second communication device 2 for simplicity.

The monitoring unit 3 includes memory 35. The memory 35 is non-transitory tangible storage medium and has a RAM, a ROM and a flash memory and the like. The ROM or the flash memory stores programs executed by a control unit (not illustrated). The flash memory stores key information 35a, 35b of the monitoring unit 3.

The key information 35a includes the private key SK3, the public keys PK3, PK1, and the common keys CK1, CK2. SK3 is a private key of the monitoring unit 3, and PK3 is the corresponding public key. The private key SK3 may be stored in a TPM (Trusted Platform Module) to prevent reading from outside of the TPM. The key information 35a is used for communication between the monitoring unit 3 and the first communication device 1. The key information 35a is used by the monitoring unit 3 so that the monitoring unit 3 acts as a proxy for the second communication device 2 in communicating with the first communication device 1. The public key PK1 is a public key of the first communication device 1. The public key PK3 corresponding to the private key SK2 is stored in the first communication device 1.

The key information 35b includes the private key SK3, the public keys PK3, PK2, and common keys CK1, CK2. SK3 is a private key of the monitoring unit 3, and PK3 is the corresponding public key. The key information 35b is used for communication between the monitoring unit 3 and the second communication device 2. The key information 35b is used by the monitoring unit 3 so that the monitoring unit 3 acts as a proxy for the first communication device 1 in communicating with the second communication device 2. The public key PK2 corresponds to the private key SK2 of the second communication device. The public key PK3 corresponding to the private key SK3 is stored in the second communication device 2.

As shown above, the common keys CK1, CK2 are stored in the first communication device 1, the monitoring unit 3, and the second communication device 2.

Additionally, in the memory 35, certificates C31 and C32 are stored. The certificate C31 is an electronic certificate to be used for the second communication device 2 to validate the monitoring unit 3 as a legitimate communication partner. When the monitoring unit 3 sends the certificate C31 to the second communication device 2, the second communication device 2 recognizes the communication with the monitoring unit 3 as the communication with the first communication device 1. For example, the certificate C31 may contain the IP address of the first communication device 1. It may also contain the public key PK3. It may also contain other data to be used to for the second communication device 2 to recognize the monitoring unit 3 as a valid communication partner.

The certificate C33 is an electronic certificate to be used for the first communication device 1 to validate the monitoring unit 3 as a legitimate communication partner. When the monitoring unit 3 sends the certificate C32 to the first communication device 1, the first communication device 1 recognizes the communication with the monitoring unit 3 as the communication with the second communication device 2. For example, the certificate C32 may contain the IP address of the second communication device 2. It may also contain the public key PK3. It may also contain other data to be used to for the first communication device 1 to recognize the monitoring unit 3 as a valid communication partner.

The router unit 4 includes network interfaces 41, 42 and memory 45. The network interface 41 is an interface circuit to communicate with the first communication device 1 via the LAN 51. The Network interface 42 is an interface circuit to communicate with the second communication device 2 via LAN 52.

Each network interface of the router unit 4 can be assigned an IP address. IP addresses P1, P2, P31, and P32 are assigned to the network interfaces 11, 21, 41, and 42, respectively.

The memory 45 is a non-transitory tangible storage medium and includes an RAM, an ROM, a flash memory and the like.

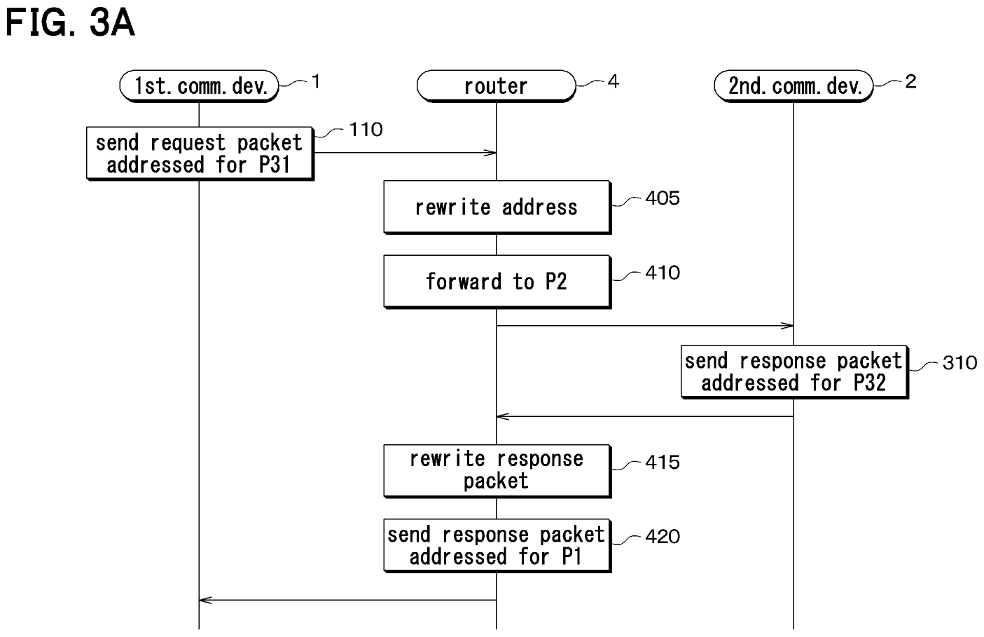

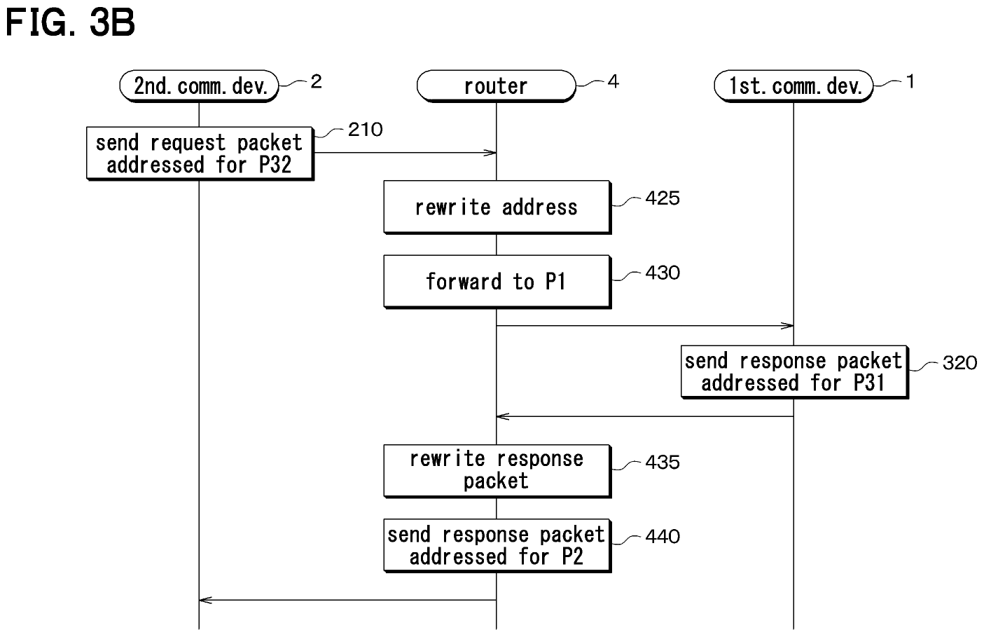

As depicted in FIG. 2B, a structure of the OPC UA Server/Client and the OPC UA Proxy is as follows. Arrows from Client #1 to the Monitoring system represent request packets, and texts on the arrows denote types of the request packets for OPC UA communication. The request packets sent from Client #1 to the Monitoring system is received by the Monitoring system and the Monitoring system forwards them to the Server #1 after altering their destination.

[Operation of proxy by the router unit 4] Hereinafter, the operation of the communication monitoring system with the aforementioned configuration is explained. First, an exemplary scenario is described with reference to FIG. 3A in which the router unit 4 communicates with the first communication device 1 in place of the second communication device 2 when the first communication device 1 attempts communication with the second communication device 2.

Initially, at Step 110, the communication device 1 creates a request packet destined for communication device 2. The request packet is a packet requesting a response during communications from the communication device 1 to the communication device 2. For example, connection requests, acknowledgement requests, disconnection requests, certificate requests, and public key requests are types of request packets. In this request packet, the destination IP address is P31 and the source IP address is P1. The communication device 1 then, at Step 110, transmits this request packet from the network interface 11 to the LAN 51.

At this moment, the router unit 4 receives this packet via the network interface 41. Upon receiving this packet, at Step 405, the router unit 4 alters the destination address of this packet. Specifically, since the destination IP address before alteration and the source IP address before alteration are respectively P31 and P1, destination IP address and source IP address is rewritten to P2 and P32, respectively.

Subsequently, the router unit 4 transmits, at Step 410, the packet with the altered destination address P2 and the altered source address P32 from the network interface 42 to the LAN 52. The transmitted packet is received by the communication device 2 via the network interface 21.

The second communication device 2 that received this packet performs processing according to the content of the transmitted data and creates a response packet. The destination IP address of this response packet is P32, and the source IP address of this response packet is P2. Then, at Step 310, the second communication device 2 sends this response packet from the network interface 21 to the LAN 52.

At this point, the router unit 4 receives this packet via network interface 42. Upon receiving this packet, the router unit 4, at Step 415, rewrites the packet's destination address. Specifically, since the destination IP address and source IP address before alteration are P32 and P2, respectively; the router unit 4 rewrites the destination IP address and source IP address to P1 and P31, respectively.

Subsequently, at Step 420, the router unit 4 sends the packet with the altered destination address P1 and the altered source addresses P31 from the network interface 41 to the LAN 51. The packet sent in this manner is received by the first communication device 1 via the network interface 11.

Through this address rewriting by the router unit 4, the packet reaches the second communication device 2 and the packet is recognized by the second communication device as originated from the Monitoring System. Consequently, the router unit 4 is capable of sending packets on behalf of the second communication device.

Next, an exemplary scenario is described with reference to FIG. 3B in which the router unit 4 communicates with the second communication device 2 in place of the first communication device 1 when the second communication device 2 attempts communication with the first communication device 1. Initially, in Step 210, the second communication device 2 creates a request packet addressed to the first communication device 1. The destination IP address of this request packet is P32, and the source IP address of this request packet is P2. Then, in Step 210, the second communication device 2 sends this request packet from the network interface 21 to the LAN 52.

At this point, the router unit 4 receives this packet via the network interface 42. Upon receiving this packet, the router unit 4, in Step 425, rewrites the packet's destination address. Specifically, since the destination IP address before alteration and the source IP address before alteration are P32 and P2, respectively, the router unit 4 rewrites the destination IP address and the source IP address to P1 and P31, respectively.

Subsequently, the router unit 4, in Step 430, sends the packet with the rewritten destination address P1 and the rewritten source addresses P31, respectively from the network interface 41 to the LAN 51. The packet sent in this manner is received by the first communication device 1 via the network interface 11.

Upon receiving this packet, the first communication device 1 performs processing based on the content of the transmitted data and creates a response packet. The destination IP address of this response packet is P31, and the source IP address of this response packet is P1. Then, in Step 320, the first communication device 1 sends this response packet from the network interface 11 to the LAN 51.

At this point, the router unit 4 receives this packet via the network interface 41. Upon receiving this packet, the router unit 4, in Step 435, rewrites the packet's destination address. Specifically, since the destination IP address before alteration and the source IP address before alteration are P31 and P1, respectively, the router unit 4 rewrites the destination IP address and the source IP address to P2 and P32, respectively.

Subsequently, in Step 440, the router unit 4 sends the packet with the rewritten destination address P2 and the rewritten source addresses P32, respectively from the network interface 42 to the LAN 52. The packet sent in this manner is received by the second communication device 2 via the network interface 21.

Through the address rewriting by the router unit 4, the packet reaches the first communication device 1 and the packet is recognized by the first communication device 1 as originated from the Monitoring System. Consequently, the router unit 4 can send packets on behalf of the first communication device.

In FIGS. 3A and 3B, when the router unit 4 rewrites destination IP addresses and source IP addresses of the packets, it refers to the conversion table 45a stored in the memory 45. Specifically, it is described in the conversion table 45a that the destination IP address P31 and the source IP address P1 in a received packet should be rewritten to the destination IP address P2 and the source IP address P32. In addition, it is described in the conversion table 45a that the destination IP address P32 and the source IP address P2 in a received packet should be rewritten to the destination IP address P1 and the source IP address P31.

When the router unit 4 rewrites the source IP address in a received packet, it may also alter the ‘endpoint description’ in the payload of the packet to match the modified source IP address. The ‘endpoint description’ is an identifier specifying the return destination in OPC UA.

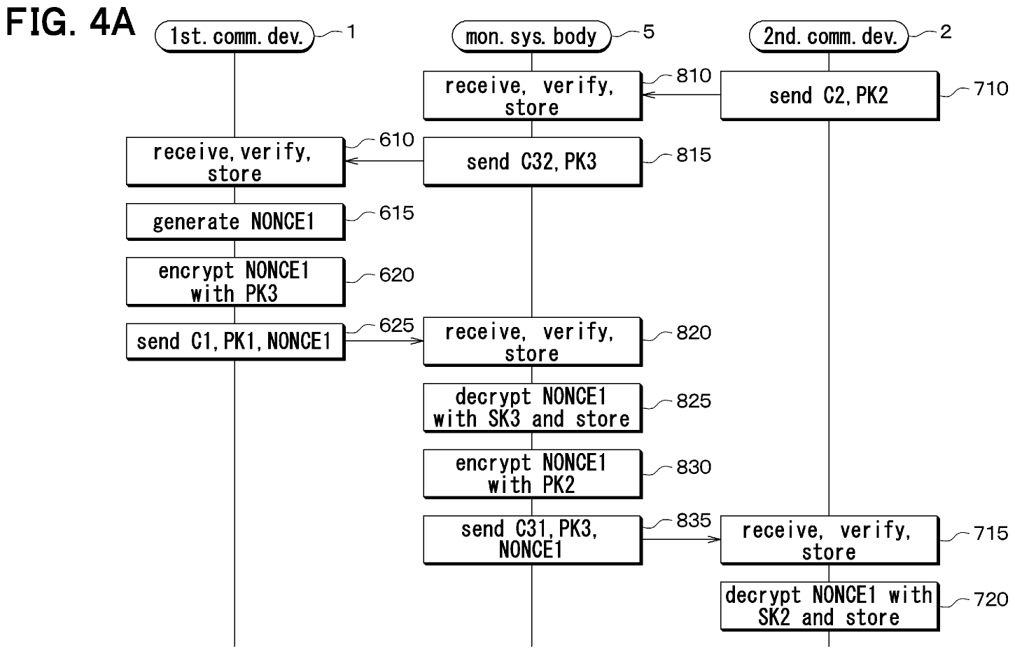

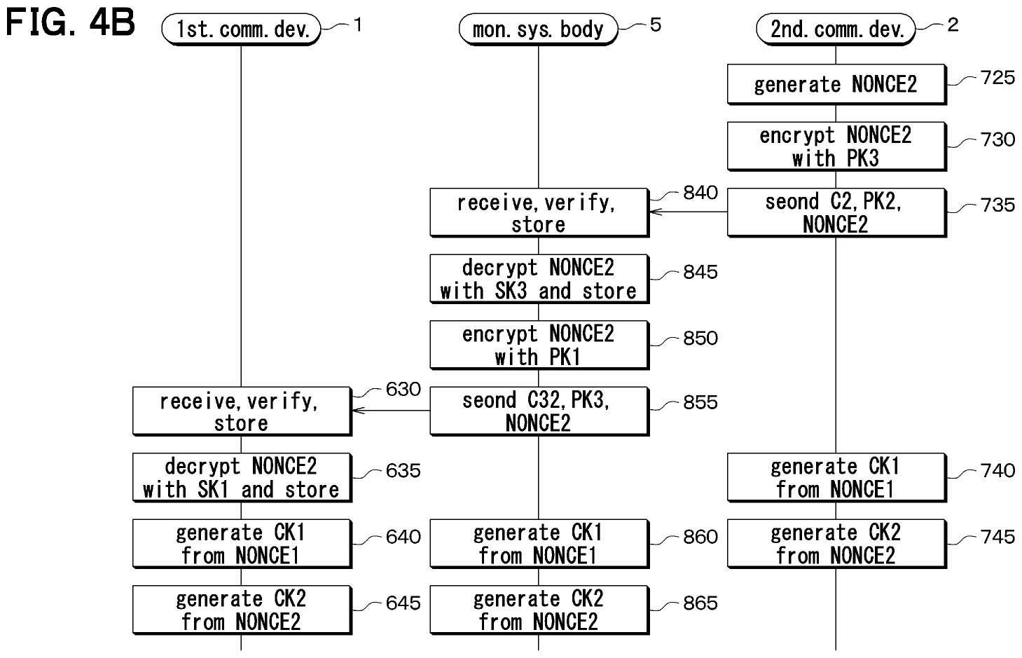

Next, with reference to FIGS. 4A and 4B, generation of the common keys CK1 and CK2 is described which uses the address alteration and the forwarding process of the router 4 shown in FIGS. 3A and 3B. This generation process occurs at a beginning of a session and the generated common keys CK1 and CK2 are retained until the end of the session. During the session, a series of bidirectional communications takes place.

Before the processes in FIGS. 4A and 4B, the first communication device 1 possesses the private key SK1, the public key PK1, and the certificate C1 in the memory 12; the second communication device 2 possesses the private key SK2, the public key PK2, and the certificate C2 in the memory 22: while the monitoring unit 3 possesses the private key SK3, the public key PK3, and the certificate C31, C32 in the memory 35.

While FIGS. 4A and 4B depict a scenario in which the second communication device 2 initiates a session, it's also possible for the first communication device 1 to initiate a session. In the latter case, in FIGS. 4A and 4B, the roles of the first communication device 1 and the second communication device 2 are interchanged.

Initially, at Step 710, the second communication device 2 sends a packet containing the certificate C2 and the public key PK2 stored in the memory 22 to the router unit 4 of the monitoring system body 5. Then, at Step 810, the monitoring system body 5 receives, verifies, and stores this packet. Specifically, the router unit 4 receives and forwards this packet to the monitoring unit 3; the monitoring unit 3 uses the certificate C2 in the packet to verify the legitimacy of the second communication device 2; and the monitoring unit 3 records the public key PK2 in the key information 35b of the memory 35.

Furthermore, at Step 815, the monitoring system body 5 replaces the certificate C2 and the public key PK2 in the payload of this packet with the certificate C32 and the public key PK3 in the memory 35, respectively, and sends the packet to the first communication device 1. For example, the router unit 4 requests the certificate C32 and the public key PK3 from the monitoring unit 3. and the monitoring unit 3 then responds by sending the certificate C32 and the public key PK3 from the memory 35 to the router unit 4. Then, the router unit 4 performs the aforementioned replacement. While the packet is sent from the second communication device 2 through the router unit 4 to the first communication device 1, the procedures for assigning, replacing and the like of the destination IP address and the source IP address for this packet are made as described above with reference to FIG. 3B.

Subsequently, at Step 610, the first communication device 1 receives this packet transmitted from the monitoring system body 5, verifies the legitimacy of the monitoring unit 3 using the certificate C32 within the packet, and records the public key PK3 in the key information 12a of the memory 12.

Subsequently, the first communication device 1, at Step 615, generates a random number NONCE1, and at Step 620, encrypts this random number NONCE1 using the public key PK3 in the key information 12a in the memory 12. Furthermore, at Step 625, the first communication device 1 sends a packet containing the certificate C1 in the memory 12, public key PK1 in the memory 12, and the encrypted random number NONCE1 to the router unit 4 of the monitoring system body 5. The monitoring system body 5 receives, verifies, and stores the packet at Step 820. Specifically, the router unit 4 receives the packet and forwards it to the monitoring unit 3. Then the monitoring unit 3 uses the certificate C1 in the packet to verify the legitimacy of the first communication device 1 and stores the public key PK1 in the key information 35a of the memory 35.

Furthermore, at Step 825, the monitoring unit 3 of the monitoring system body 5 decrypts the random number NONCE1 in the payload of this packet using the private key SK3 in the memory 35 and saves the decrypted random number NONCE1 in the memory 35. Then, at Step 830, the monitoring unit 3 encrypts the decrypted random number NONCE1 using the public key PK2 in the memory 35 and sends the encrypted random number NONCE1, the certificate C31 in the memory 35 and the public key PK3 in the memory 35 to the router unit 4.

Then, at Step 835, the router unit 4 in the monitoring system body 5 replaces the certificate C1, public key PK1, and the encrypted random number NONCE1 in the packet received at Step 820 with the certificate C31 received from the monitoring unit 3, the public key PK3 received from the monitoring unit 3, and the encrypted random number NONCE1, respectively. Subsequently, the router unit 4 sends the packet with the replaced content to the second communication device 2.

While the packet is sent from the first communication device 1 through the router unit 4 to the second communication device 2, the procedures for assigning, replacing and the like of the destination IP address and the source IP address for this packet are made as described above with reference to FIG. 3B.

Next, the second communication device 2, at Step 715, receives the packet sent from the monitoring system body 5, verifies the legitimacy of the monitoring unit 3 using the certificate C31 in the packet, and records the public key PK3 in the key information 22a of the memory 22. Then, at Step 720, the second communication device 2 decrypts the random number NONCE in the received packet using the private key SK2 and stores the decrypted random number NONCE1 in the memory 22.

Following this the second communication device 2 generates at Step 725 in FIG. 4B a random number NONCE2 and encrypts at Step 730 this random number NONCE2 using the public key PK3 in the key information 22a. Further at Step 735, the second communication device 2 sends a packet containing the certificate C2 in the memory 22, the public key PK2 in the memory 22 and the encrypted random number NONCE2 to the router unit 4 of the monitoring system body 5. The monitoring system body 5 receives, verifies, and stores the packet at Step 840. Specifically, the router unit 4 receives the packet and forwards it to the monitoring unit 3. Then the monitoring unit 3 uses the certificate C2 in the packet to verify the legitimacy of the second communication device 2 and stores the public key PK2 in the key information 35a of the memory 35.

Furthermore, at Step 845, the monitoring unit 3 in the monitoring system body 5 decrypts the random number NONCE2 in the payload of this packet using the private key SK3 in the memory 35 and saves the decrypted random number NONCE2 in the memory 35. Then, at Step 850, the monitoring unit 3 encrypts the decrypted random number NONCE2 using the public key PK1 in the memory 35 and sends the decrypted NONCE2, the certificate C32 in the memory 35 and the public key PK3 in the memory 35 to the router 4.

Then, at Step 855, the router unit 4 in the monitoring system body 5 replaces the certificate C2, the public key PK2 and the encrypted random number NONCE2 in the packet received at Step 840 with the certificate C32 received from the monitoring unit 3, the public key PK3 received from the monitoring unit 3, and the encrypted random number NONCE2, respectively. Subsequently, the router unit 4 sends the packet with the replaced content to the first communication device 1.

While the packet is sent from the second communication device 2 through the router unit 4 to the first communication device 1, the procedures for assigning, replacing and the like of the destination IP address and the source IP address for this packet are made as described above with reference to FIG. 3B.

Subsequently, at Step 630, the first communication device 1 receives this packet sent from the monitoring system body 5, verifies the legitimacy of the monitoring unit 3 using the certificate C32 in the packet, and records the public key PK3 in the key information 22a of the memory 22. Following this, at Step 635, the first communication device 1 decrypts the random number NONCE2 in the received packet using the private key SK1 and stores the decrypted random number NONCE2 in the memory 12.

Through this packet exchange, both of the decrypted random number NONCE1 and random number NONCE2 are saved in each of the first communication device 1, the second communication device 2, and the monitoring system body 5. Based on the random number NONCE1 and the random number NONCE2, the common keys CK1 and CK2 are generated, respectively.

Specifically, at Step 640 following Step 635, the first communication device 1 generates the common key CK1 from the random number NONCE1 and records the common key CK1 in the key information 12a of the memory 12. Furthermore, at Step 645, the first communication device 1 generates the common key CK2 from the random number NONCE2 and records the common key CK2 in the key information 12a.

Additionally, at Step 740 following Step 735, the second communication device 2 generates the common key CK1 from the random number NONCE and records the common key CK1 in the key information 22a of the memory 22. Further at Step 745, the communication device 2 generates the common key CK2 from the random number NONCE2 and records the common key CK2 in the key information 22a.

Additionally, at Step 860 following Step 855, the monitoring unit 3 of the monitoring system body 5 generates the common key CK1 from the random number NONCE1 and records the common key CK1 in the key information 35a and 35b of the memory 35. Furthermore, at Step 865, the monitoring unit 3 generates the common key CK2 from the random number NONCE2 and records the common key CK2 in the key information 35a and 35b.

The algorithm for generating the common key CK1 from the random number NONCE1 is the same for the first communication device 1, the second communication device 2, and the monitoring unit 3. Moreover, the algorithm for generating the common key CK1 from the random number NONCE1 ensures that if the value of the random number NONCE1 varies, the generated value of the common key CK1 also varies. Therefore, the same value of the random number NONCE1 results in the generation of the same value of the common key CK1 using the same algorithm in the first communication device 1, the second communication device 2, and the monitoring unit 3.

The algorithm for generating the common key CK2 from the random number NONCE2 is the same for the first communication device 1, the second communication device 2, and the monitoring unit 3. Also, the algorithm for generating the common key CK2 from the random number NONCE2 ensures that if the value of the random number NONCE2 varies, the generated values of the common key CK2 also varies. Hence, the same value of the random number NONCE2 results in the generation of the same value of the common key CK2 using the same algorithm in the first communication device 1, the second communication device 2, and the monitoring unit 3. Additionally, note that the algorithms for generating the common key CK1 from the random number NONCE1 and for generating the common key CK2 from the random number NONCE2 may be the same or different. The values of the common keys CK1 and CK2 are different since the values of the random number NONCE1 and the random number NONCE2 are different.

After the common keys CK1 and CK2 are generated, the common key CK1 is used for encrypting and decrypting the payload in packets sent from the first communication device 1 to the second communication device 2 through the monitoring system body 5. The common key CK2 is used for encrypting and decrypting the payload in packets sent from the second communication device 2 to the first communication device 1 through the monitoring system body 5.

### [Operation of Relay by Monitoring Unit 3]

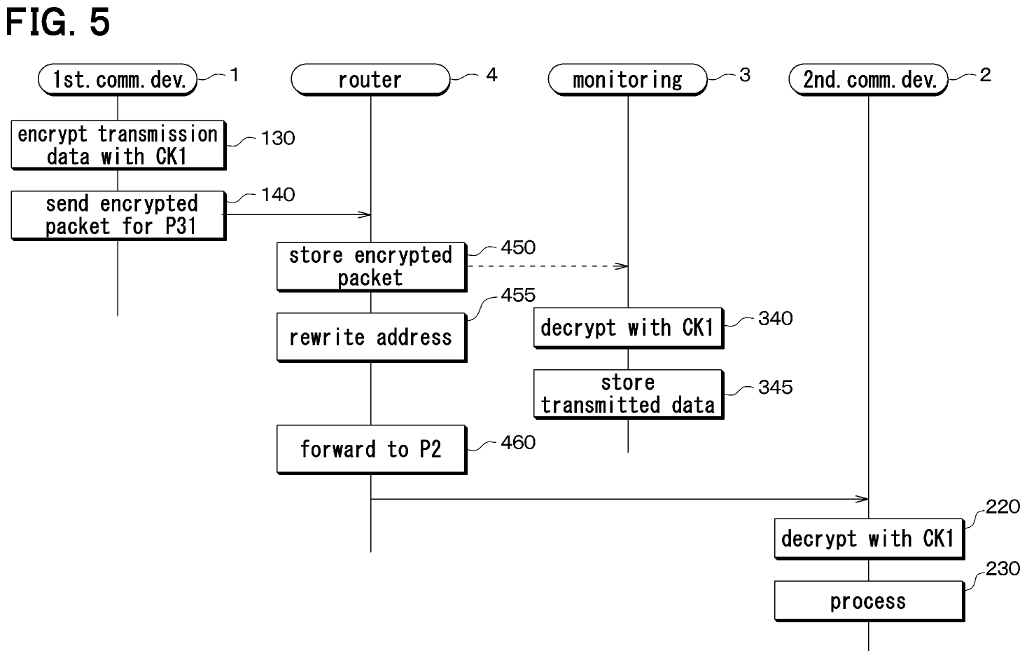

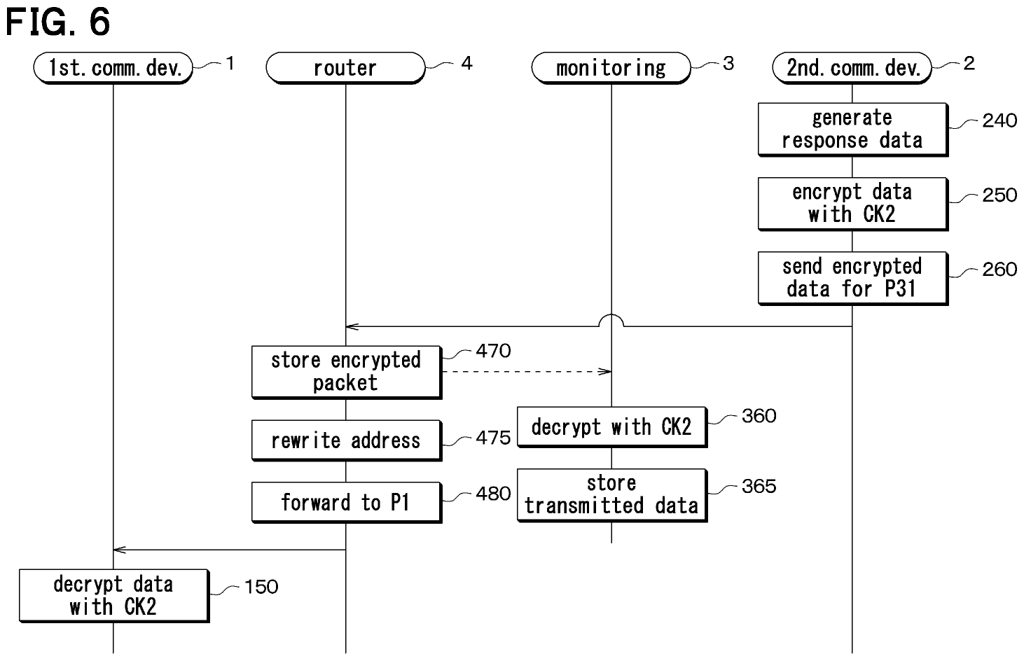

Hereinafter, referring to FIGS. 5 and 6, a scenario is described where the monitoring unit 3 communicates with the first communication device 1 instead of the second communication device 2 when both the first communication device 1 and the second communication device 2 attempt to exchange data in a session after the common keys CK1 and CK2 are generated. A case is described where a packet is sent from the first communication device 1 to the second communication device 2 and, based on the content of the packet, a packet is subsequently sent from the second communication device 2 to the first communication device 1. However, even if the roles of the first communication device 1 and the second communication device 2 are reversed, equivalent processing is achieved.

Hereinafter, this scenario is described. Initially, at Step 130, the first communication device 1 creates transmission data for sending to the second communication device 2 and encrypts the created transmission data. The content of the transmission data may be, for example, instructions for making the second communication device 2 perform a specific action (e.g. controlling an actuator).

Symmetric key encryption method is used in this encryption. In OPC-UA, as mentioned earlier, a hybrid approach is adopted where an asymmetric key encryption method is employed as described above in establishing session, exchanging common keys and the like, and a symmetric key encryption method using session-specific common keys generated in each session is employed in exchanging data.

The transmitting device (in Step 130, the first communication device 1) encrypts the data (i.e., payload) in the packet for transmission using an encryption method according to a procedure specified by the hybrid approach.

During the encryption of the data at Step 130, the data are encrypted using the common key CK1.

The destination of this packet is the second communication device 2. However, the actual destination IP address of this packet is P31, and the source IP address is P1.

Then, the router unit 4 receives this packet via the network interface 41. Upon receiving this packet, the router unit 4, at Step 450, forwards the packet to the monitoring unit 3. Upon receiving this packet, the monitoring unit 3, at Step 340, decrypts the payload of this packet using the common key CK1. While the monitoring unit 3 possesses two common keys CK1, CK2, the monitoring unit 3 uses CK2 as the common key for decryption at this point based on the information that the source IP address of the packet is P1,

At Step 345, the monitoring unit 3 records the plaintext transmission data (i.e., content to be communicated) decrypted in the preceding Step 340 in the memory 35. During this process, if there is an anomaly in the transmitted data, the anomaly may be notified to an operator of the monitoring unit 3. The notification method may include sending an email or activating an unillustrated notification device. The monitoring unit 3 may determine the presence of anomalies in the transmitted data, for example, by assessing if instructions contained in the transmitted data are predetermined abnormal instructions. The procedures from Step 450 to Step 455 and the transition from Step 450 to Step 340 are performed through parallel processing.

Furthermore, at Step 455, the router unit 4 rewrites the packet's destination address. Specifically, since the destination IP address before alteration and the source IP address before alteration are P31 and P1, respectively, the destination IP address and the source IP address are rewritten to P2 and P32, respectively:

Subsequently, the router unit 4 sends the packet with the rewritten destination address P2 and source addresses P32 from the network interface 42 to LAN52. This packet, thus transmitted, is received by the second communication device 2 via the network interface 21.

Upon receiving this packet, the second communication device 2, at Step 220, decrypts the payload of this packet using the common key CK1. Consequently, the second communication device 2 obtains the plaintext transmission data.

Subsequently, at Step 230, the second communication device 2 performs processing based on the content of this transmission data. For example, if the transmission data contains control instructions, the second communication device 2 controls an actuator according to the instructions.

In this way, packets sent from the first communication device 1 to the second communication device 2 allow for content monitoring.

Subsequently, after Step 230, the second communication device 2, at Step 240 in FIG. 6, generates response data. For example, if the transmission data includes control instructions and the second communication device 2 controlled an actuator based on the instructions at Step 230, the communication device 2 makes the response data include result of the control of the actuator. Subsequently, at Step 250, the second communication device 2 encrypts the response data created at Step 240 using the common key CK2. The common key CK2 used at this time is created in updating a session mentioned above, and is shared between the first communication device 1, the second communication device 2, and the monitoring unit 3.

Next, at Step 260, the second communication device 2 creates a packet having the data encrypted at the preceding Step 250 as a payload and having the source address as P2 and the destination address as P32, and sends this packet from the network interface 21 to the LAN52.

The target of this packet is the first communication device 1. However, the actual destination IP address is P1, and the source IP address remains as described above.

Subsequently, the router unit 4 receives this packet via the network interface 42. Upon receiving the packet, the router unit 4 rewrites at Step 475 the packet's destination address according to the conversion table 45a. Specifically, since the destination IP address before alteration is P1, the destination IP address is rewritten to P31 as shown in FIG. 2A.

Subsequently, the router unit 4 sends the packet with the rewritten destination address P1 and the source address P31 from the network interface 41 to the LAN51. The packet transmitted in this manner is received by the first communication device 1 via the network interface 11.

Upon receiving this packet, the first communication device 1, at Step 150, decrypts the payload of this packet using the common key CK2. Consequently, the first communication device 1 obtains the plaintext response data.

This packet is sent from the router unit 4 to the monitoring unit 3. Thus, at Step 470, the packet is forwarded by the router unit 4 to the monitoring unit 3.

Upon receiving this packet, the monitoring unit 3, at Step 360, decrypts the payload of this packet using the common key CK2. Although the monitoring unit 3 possesses two common keys CK1 and CK2, the monitoring unit 3 uses at this point CK2 as the common key for decryption based on the information that the packet's source IP address is P2. This decryption yields the plaintext response data.

Subsequently, at Step 365, the monitoring unit 3 records the decrypted plaintext response data (i.e., content to be communicated) in the memory 35. At this time, if there is a predetermined anomaly in the content of the response data, the monitoring unit 3 may alert the operator about the anomaly as is done at Step 345. The procedures from Step 470 to Step 475 and from Step 450 to Step 360 are performed in parallel.

The common key CK2 is a cryptographic key shared among the first communication device 1, the second communication device 2, and the monitoring unit 3. The common key CK2 used at this time is generated in updating a session and shared among the first communication device 1, the second communication device 2, and the monitoring unit 3.

In this embodiment, as shown in the processes in FIG. 3A, when the monitoring unit 3 receives a request packet addressed from the first communication device 1 to the second communication device 2, the monitoring unit 3 sends a response packet to the first communication device1 that is the source of this request packet. In addition, as shown in the processes in FIG. 3B, when the monitoring unit 3 receives a request packet addressed from the second communication device 2 to the first communication device 1, the monitoring unit 3 sends a response packet to the second communication device2 that is the source of this request packet. In short, on receiving a request packet which needs a response, the monitoring unit 3 responds to the first communication device 1 as a proxy for the second communication device 2 in the processes in FIG. 3A and responds to the second communication device 1 as a proxy for the first communication device 1 in the processes in FIG. 3B

Furthermore, in the processes depicted in FIG. 5, the monitoring unit 3 selects payloads of packets that need to reach the second communication device 2 among packets that are sent from the first communication device 1 for the second communication device 2 and forwards the selected payloads directly without decryption to the second communication device 2. In addition, in the processes depicted in FIG. 6, the monitoring unit 3 selects payloads of packets that need to reach the first communication device 1 among packets that are sent from the second communication device 2 for the first communication device 1 and forwards the selected payloads directly without decryption to the first communication device 1.

Thus, for packets for setting up communications or acknowledging communications, the monitoring unit 3 handles them between the monitoring unit 3 and each of the communication devices 1 and 2 as shown in FIGS. 3A and 3B, while serves as a relay point for data communication packets as depicted in FIGS. 5 and 6.

As explained, the first communication device 1 and the second communication device 2 do not communicate directly with each other but communicate via the router unit 4. While the first communication device 1 transmits packets targeted for the second communication device 2, these packets are sent to the monitoring unit 3 by the router unit 4. To enable decryption of encrypted data from the first communication device 1 at the monitoring unit 3, encryption with a key shared between the first communication device 1 and the monitoring unit 3 is performed by the first communication device 1. Wile, alteration of destination addresses is done at the router unit 4 (Steps 450, 455), the packet received by the monitoring unit 3 is decrypted using the key shared between the first communication device 1 and the monitoring unit 3 and then recorded (Step 345).

For example, if the second communication device 2 serves as the aforementioned controller, considering that the controller is designed to obey even dangerous instructions, monitoring the content of communications in the control network for potentially dangerous instructions is required. If a malicious intruder gains access to the legitimate first communication device 1 capable of sending instructions to the controller and makes it transmit malicious instructions, it poses a risk of accidents occurring. To monitor if such communication is happening, interpretation of the content of the payloads in the packets is necessary. However, when the payloads are encrypted, even if packets are intercepted midway, the content of the payloads becomes incomprehensible. The aforementioned monitoring unit 3 and the router unit 4 address this issue.

Moreover, the information monitored by the monitoring unit 3 is desired to be stored securely even if attackers intrude into the control network, evading attacks. In this embodiment, the aforementioned monitoring unit 3 and router unit 4 enable monitoring and recording of the encrypted content of the communication without revealing the presence of the monitoring unit 3.

Additionally, since communication is bidirectional, encryption and decryption are performed in the reverse direction. The shared key CK1 used for encryption by the first communication device 1 is shared among the first communication device 1, the second communication device 2, and the monitoring unit 3. Therefore, even if communication packets from the first communication device 1 directly reach the second communication device 2, they can be decrypted.

As such, encrypted packets sent from the first communication device 1 for the second communication device 2 can be decrypted at the second communication device and monitored, just because the encrypted packets pass the monitoring unit 3 and router unit 4. When conducting encrypted communication among three or more communication devices, not only between the first communication device 1 and the second communication device 2, all communication is routed through the router unit 4, and the common keys CK1 and CK2 used for encryption/decryption among all communication devices and the monitoring unit 3 are shared.

In this embodiment, the router unit 4 serves as an acquisition unit by executing Steps 450 and 455, serves as a forwarding unit by executing Steps 460 and 465, and serves as a request packet transfer unit by executing Steps 405 and 410. Additionally, the monitoring unit 3 serves as a decryption unit by executing Step 340 and serves as a recording unit by executing Step 345. Furthermore, the common key CK1 corresponds to the first encryption key and the common key CK1 corresponds to the first decryption key. In addition, the common key CK2 corresponds to the second encryption key, and the common key CK2 corresponds to the second decryption key:

### Other Embodiments

The present invention is not limited to the above-described embodiments and can be appropriately modified. Additionally, in the embodiments described above, the elements constituting the embodiments are not necessarily essential unless explicitly stated as essential or considered essential in principle. Moreover, specific numbers, values, quantities, ranges, etc., mentioned regarding the components of the embodiments are not limited to those specific numbers unless explicitly stated as essential or inherently limited to a specific number. Particularly, when multiple values are exemplified for a certain quantity, it's possible to adopt values between those multiples unless specified otherwise or inherently impossible. Furthermore, the following variations and other modifications within an equivalent range to the embodiments described above are also allowed. These variations can be applied or not applied independently to the above embodiments. That is, any combination of these variations that does not explicitly contradict each other can be applied to the embodiments above.

### (Variation 1)

In OPC UA proxy, a static “FromTo” table (static table) is maintained in the proxy to facilitate routing. This static table has the advantage of minimal processing overhead due to the unique determination of the “FromTo.” The router unit 4 in the aforementioned embodiment corresponds to the OPC UA Proxy, and the conversion table 45a corresponds to the static table. Hence, specifying the routing information for packets between the first communication device 1, the second communication device 2, and the router unit 4 is achieved through the conversion table 45a. However, due to its static nature, manual configuration of the “FromTo” is necessary, leading to increased configuration effort as the number of OPC UA proxies through which it passes increases. Additionally, disadvantage may occur in which manual configuration tends to increase human errors, such as configuration mistakes and the like.

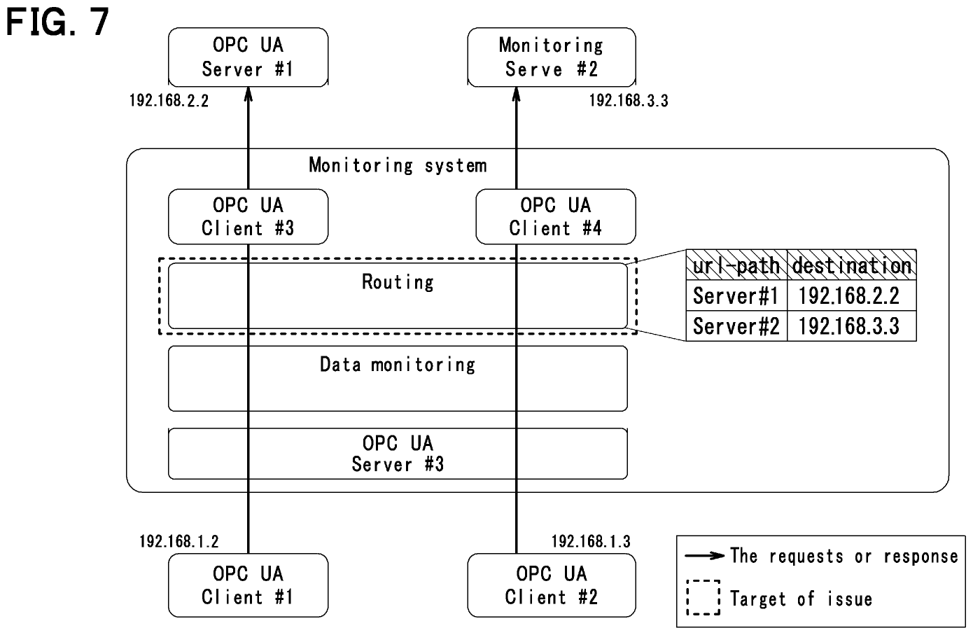

As depicted in FIG. 7, routing information may be specified using URLs as follows. In order to specify from the OPC UA Client, the OPC UA Proxy's IP address+port number is designated as the resource section and the OPC UA Server's IP address+port number is designated as the identifier. For example, if connecting from the OPC UA Client #1 (e.g., the first communication device 1) to the OPC UA Server #1 (e.g., the second communication device 2) via the OPC UA Proxy (e.g., the router unit 4), the OPC UA Client #1 specifies “opc.tcp://OPC UA Proxy's IP address/OPC UA Server #1's IP address.”

Subsequently, in the communication initiated by this URL designation between the OPC UA Client #1 and the OPC UA Server #1, the information of this URL is sent from the OPC UA Client #1 to the OPC UA Proxy (the Monitoring System in FIG. 7). The OPC UA Proxy then, based on the description within this URL, forwards the packet sent from the OPC UA Client #1 to the OPC UA Server #1 and forwards a response packet to the OPC UA Client #1, wherein the response packet is sent from the OPC UA Server #1 to the OPC UA Proxy as a response to the aforementioned packet.

Here, a URL, abbreviated from Uniform Resource Locator, refers to the subset of URIs that, in addition to identifying a resource, provide a means of locating the resource by describing its primary access mechanism (e.g., its network “location”). A URI, abbreviated from Uniform Resource Identifier, is a compact sequence of characters that identifies an abstract or physical resource.

Generally, a URL follows the syntax of “protocol”+“resource (remote host)”+“identifier.” The protocol specifies a convention name like HTTP or MQTT. The resource points to the remote host, specifying domain names or IP addresses. If necessary, a port number can be specified separated by a colon (:). The identifier typically designates a unique identifier for the location within a target of connection. For TCP communication in OPC UA, the protocol would be specified as “opc.tcp”. The resource refers to a domain name or an IP address, and if needed, a port number can be specified separated by a colon (:).

In other words, the routing method for the destination may be, instead of using a static “From To”, a routing method that enables communication between the first communication device 1 and the second communication device 2 in the manner that the “resource (remote host)” of the second communication device 2 is specified as the URL's identifier part. The resource refers to domain names or IP addresses, and if needed, a port number can be specified separated by a colon (:).

### (Variation 2)

In the aforementioned embodiment, the request and response packets constitute the outgoing and incoming packets, respectively, in a single round-trip communication. However, the request and response packets may be an outgoing packet and an incoming packet within a series of multiple round-trip communications forming a session, wherein the incoming packet is one of the incoming packets in the session that comes later than the first incoming packet after the outgoing packet. This is because, in the latter case, the incoming packet constituting the request and response packets is generated due to the transmission of the request packet.

### (Variation 3)

The embodiment above describes a one-to-one communication between the first communication device 1 and the second communication device 2. However, besides this form of communication, the communication monitoring system is applicable to embodiments where two or more communication devices communicate one-to-one with an equal number of other communication devices. In such a case, two or more communication devices have fixed communication partners.

### (Variation 4)

In the above-described embodiment, the monitoring unit 3 possesses key information 35a for communicating with the first communication device 1 and key information 35b for communicating with the second communication device 2. However, it is also possible for the monitoring unit 3 to have a single set of key information for communicating with both the first communication device 1 and the second communication device 2.

### (Variation 5)

In the above embodiment, the monitoring unit 3, at Steps 345 and 365, may transmit data to be recorded in the memory 35 to a recording device in a network different from the control network. The recording unit stores this data transmitted in such a manner on a storage medium. This approach protects the recorded monitoring data from cyber attacks by placing the recording device in a separate network, thereby securely transmitting the monitoring data to the recording unit, securing the forensically valid data.

### (Variation 6)

In the described embodiment, the control units 13 of the first communication device 1, the control unit 23 of the second communication device 2 and the monitoring unit 3 perform encryption and decryption of data. However, each of the control units 13, 23, and monitoring unit 3 in the first communication device 1, the second communication device 2, and the monitoring unit 3, respectively, may utilize separate devices (e.g., TPM security modules) to handle the encryption and decryption processes.

### (Variation 7)

In the above embodiment, two common keys CK1 and CK2, are exemplified as the keys shared among the first communication device 1, the second communication device 2, and the monitoring unit 3. However, a single common key shared among the first communication device 1, the second communication device 2, and the monitoring unit 3 would also be acceptable. For example, if the shared common key among the first communication device 1, the second communication device 2, and the monitoring unit 3 is solely CK1, the data could be encrypted with the common key CK1 at Step 250 in FIG. 6 and decrypted with the common key CK1 at Step 360. In such a scenario, the generation, transmission, and creation of the common key CK2 based on the random number NONCE2 in FIG. 4B would be unnecessary.

### (Variation 8)

In the described embodiment, the first encryption key and the first decryption key are both the same common key CK1. However, the first encryption key and the first decryption key could be different. For example, the first encryption key could be a certain public key, while the first decryption key could be a private key corresponding to the public key. In this case, a key pair consisting of the encryption key and the public key may be generated from the common random number NONCE1 by the first communication device 1, the second communication device 2, and the monitoring unit 3. The same concept applies to the second encryption key and the second decryption key. For example, the second encryption key could be a certain public key, while the second decryption key could be a private key corresponding to the public key.

### INDUSTRIAL APPLICABILITY

OPC UA represents a novel communication technology in the industrial sector. In 2015, the German government introduced OPC UA as the next-generation communication technology to realize Industry 4.0 at the Hanover Fair. As a result, it has been recognized as the standard for communication worldwide, indicating a high likelihood of OPC UA becoming the standard specification in the industrial sector. Consequently, monitoring encrypted communication becomes crucial in the event of PCs or embedded devices being compromised by cyber attacks. The present invention facilitates the monitoring of data flowing on encrypted networks, the directionality of data, or API parameter monitoring by deploying it at the boundaries of zone-separated networks.
1 . . . first communication device, 2 . . . second communication device, 3 . . . monitoring unit, 4 . . . router unit, 5 . . . monitoring system main body, 11, 21, 41, 42 . . . network interfaces, 12a, 22a, 35a, 35b . . . key information, 51, 52 . . . LAN, C1, C2, C31, C32 . . . certificates

1. A monitoring system for monitoring communication between a first communication device and a second communication device in a control network, comprising:
a router unit capable of communication with the first communication device and the second communication device, and
a monitoring unit recording information regarding content of communication between the first communication device and the second communication device,
wherein:
the router unit includes an acquisition unit obtaining a packet encrypted with a first encryption key by the first communication device and sent from the first communication device,
the monitoring unit includes a decryption unit decrypting the packet obtained by the acquisition unit with a first decryption key corresponding to the first encryption key and a recording unit recording information based on the decrypted packet,
the router unit includes a transfer unit transmitting the encrypted packet to the second communication device,
the router unit and the monitoring unit function as OPC UA application integrated within encrypted communications, are equipped with OPC UA server/client functionalities, capable of OPC UA encryption/decryption, and make an inquiry to an OPC UA server that is the second communication device as a proxy for an OPC UA client that is the first communication device.

2. The monitoring system according to claim 1, wherein
the first communication device, the second communication device, and the monitoring unit are all capable of communication through the router unit, wherein the acquisition unit within the router unit alters a destination address of the packet and sends them from the transfer unit,
the packet originating from the first communication device has a source address being an address of the first communication device and the destination address being an address of the router unit and reaches the router unit,
at the initiation of communication, the acquisition unit acquires a common key shared between the OPC UA client and the OPC UA server.

3. The monitoring system according to claim 2, wherein
the router unit and the monitoring unit are capable of communication with each other,
the router unit includes a request packet transfer unit rewriting, at the initiation of communication, a destination address of a specific request packet sent from the first communication device from an address of the router unit to an address of the second communication device and sending the rewritten packet to the second communication device,
the second communication device includes a response unit sending to the router unit a response packet in response to the request packet sent by the request packet transfer unit, by setting a destination address to an address of the router unit and by setting a source address to the address of the second communication device, and
the router unit changes the source address of the response packet sent by the response unit from the address of the second communication device to an address of the router unit and sends the response packet to the first communication device.

4. The monitoring system according to claim 3, wherein the request packet from the first communication device includes an electronic certificate of the first communication device, and the corresponding response packet contains an electronic certificate of the monitoring unit.

5. The monitoring system according to claim 4, wherein the request packet from the first communication device includes a public key corresponding to a private key owned by the first communication device, and the response packet includes a public key corresponding to a private key owned by the monitoring unit.

6. The monitoring system according to claim 5, wherein a request packet from the second communication device includes a public key corresponding to a private key owned by the second communication device, and a corresponding response packet includes a public key corresponding to a private key owned by the monitoring unit.

7. The monitoring system according to claim 6, wherein the first communication device and the monitoring unit share a common key, and the second communication device and the monitoring unit also share a common key.

8. The monitoring system according to claim 1, wherein packet routing information between the first communication device, the second communication device, and the router unit is specified using a URL.

9. The monitoring system according to claim 1, wherein the first encryption key and the first decryption key are obtained by the first communication device, the second communication device, and the monitoring unit based on information shared among the first communication device, the second communication device, and the monitoring unit through communication using asymmetric key encryption.

10. The monitoring system according to claim 1, wherein
the router unit obtains a packet encrypted with a second encryption key at the second communication device and sent from the second communication device,
the monitoring unit decrypts, using a second decryption key corresponding to the second encryption key, the packet obtained from the second communication device and encrypted with the second encryption key at the second communication device and records information based on the decrypted packet, and
the router unit sends the packet encrypted with the second encryption key by the second communication unit to the first communication device.
